(19) United States
(12) Patent Application Publication
(10) Pub. No.: US 2008/0263079 A1
(43) Pub. Date: Oct. 23, 2008

(54) DATA RECOVERY IN AN ENTERPRISE DATA STORAGE SYSTEM

(75) Inventors: DEEPAK SONEJI, DUBLIN, CA (US); EVAN ZHANG, MILPITAS, CA (US)

Correspondence Address: MARSH, FISCHMANN & BREYFOGLE LLP, 8055 East Tufts Avenue, Suite 450, Denver, CO, 80237, US

(73) Assignee: FLEXTRONICS AP, LLC

(21) Appl. No.: 11/876,191

(22) Filed: Oct. 22, 2007

Related U.S. Application Data
(60) Provisional application No. 60/862,741, filed on Oct. 24, 2006.

(51) Int. Cl. G06F 17/30

(52) U.S. Cl. 707/102; 707/202; 707/E17.045; 707/E17.032

(57) ABSTRACT

Systems and methods (i.e. the “utility”) presented herein generally provide for data recovery and use of backup data for various applications. More specifically, the utility provides a means for testing data recovery and other database applications on actual data without interfering with general database functionality. For example, the utility may overcome problems associated with “refreshing” by providing a “snapshot” of the ERP systems being monitored by a disaster recovery system. In this regard, the utility may configure software pointers to point to blocks of the ERP data being monitored as opposed to physically copying every block of ERP data. That is, the software pointers generally provide a “view” into the actual data (i.e., the disaster recovery duplicate of the data) and require little storage (e.g., a few megabytes or less). Thus, actual data of the ERP system may be tested via the pointers without interruption to the failover site databases.

### CROSS REFERENCE TO RELATED APPLICATIONS

This patent application claims priority to, and thus the benefit of an earlier filing date from, U.S. Provisional Patent Application No. 60/862,741 (filed Oct. 24, 2006 and entitled “ERP Disaster Recovery Test System”; Attorney Docket No. 50224-00089), the entire contents of which are hereby incorporated by reference.

### BACKGROUND

Enterprise Resource Planning systems (ERPs) are used to support data processes. For example, ERPs may integrate data and processes of an organization into a single unified system. A typical ERP system may use multiple components of computer software and hardware to achieve the integration, such as a single, unified database to store data for the various system modules. Since ERPs are computer systems that operate on data, they are susceptible to the same data loss problems as common computer users experience; however, the data loss problems of ERPs are generally on a much larger scale. For example, an ERP system may be used to control the payroll of a company with 100,000 employees (e.g., a Fortune 500 company). When this payroll data is lost, the company may fail in paying its employees, which in turn can have crippling effects on the company.

To overcome such data loss problems, companies have employed disaster recovery systems with failover sites that provide redundancy in case an ERP system fails. For example, a failover site may provide a backup copy of a particular ERP system's data. This backup copy of the data may be used when a primary ERP system fails. Additionally, any one failover site may be and typically is used by a plurality of companies such that the costs associated with redundancy are shared.

To ensure the integrity of the disaster recovery system, companies have implemented disaster recovery tests that operate on real data. For example, a company may generate a test case in software that evaluates actual data that is being provided from the company's ERP system. In this regard, the disaster recovery system may make a backup copy of the ERP data. The test software may then be configured to operate on the backup copy of the ERP data. The data that is provided to the test software for the purposes of running a test is generally referred to as “refresh data”. The process for creating the refresh data generally places one of the largest burdens on a disaster recovery system. With the refresh data in hand, the test software may be configured to more effectively evaluate the capabilities of disaster recovery system because the test is more apt to meet the company's disaster recovery requirements.

To generate the refresh data (e.g., perform a “refresh”), disaster recovery systems make a complete copy of the ERP data. The ERP data for many companies could be and generally is in the range of terabytes. To move this much data, however, even at today's high data rate capabilities, requires a tremendous amount of time. For example, to transfer 1 terabyte of data at 100 megabauds per second would take over 22 hours. Additionally, other companies wishing to perform a test generally lose their stored test cases when a refresh is to be performed.

### SUMMARY

Systems and methods (i.e., the “utility”) presented herein generally provide for data recovery and use of backup data for various applications. More specifically, the utility provides a means for testing data recovery and other database applications on actual data without interfering with general database functionality. For example, the utility may overcome problems associated with “refreshing” by providing a “snapshot” of the ERP systems being monitored by a disaster recovery system. In this regard, the utility may configure software pointers to point to blocks of the ERP data being monitored as opposed to physically copying every block of ERP data. That is, the utility may create software pointers that provide a “view” into the actual data (i.e., the disaster recovery duplicate of the data) and generally require little storage (e.g., a few megabytes or less). The software pointers can, therefore, be transferred quickly and easily using a table management system. For example, the software pointers can be managed with a software table that provides quick access to the software pointers and, thus, quick access to the actual ERP data. Accordingly, when a company desires a refresh, the utility may access the company's actual ERP data (i.e., via the disaster recovery system) by means of the software pointers (and the table management system) in very little time (e.g., a matter of seconds as opposed to hours or days). This allows every company to test their disaster recovery software more often and ensure that their data will not be lost.

In one embodiment, a system for testing data includes a first database that stores data from a plurality of computers of a network and a processor that is communicatively coupled to the first database and configured for generating a second database. The second database is linked to the first database with a plurality of pointers and wherein the pointers are associated with data elements of the first database. In this regard, the processor may include software instructions to provide the plurality of pointers to the data elements within the first database in the form of software pointers. The system also includes an interface communicatively coupled to the processor to provide at least a portion of the second database for testing without interruption to the data of the first database. The system may also include a third database that is communicatively coupled to the plurality of computers of the network to store the data therefrom. For example, the first database may be an enterprise resource planning recovery database that is communicatively coupled to the third database to replicate the data therefrom.

At least a portion of the plurality of computers may be associated with a first entity that includes at least one information technology computer configured for linking to the processor to access the least a portion of the second database. In this regard, the at least one information technology computer may be further configured for operating on data elements of the at least a portion of the second database. The system may also include an interface configured for communicatively coupling the at least one information technology computer to the processor.

In another embodiment, a method of recovering data in a networked storage system includes copying data from a first storage system to a second storage system, linking a third storage system to the second storage system, and referencing the data of the second storage system to the third storage in response to linking the third storage system. For example, referencing may include providing a plurality of pointers from the third storage system to data elements of the second storage system. In this regard, providing a plurality of pointers may include processing software instructions to generate a plurality of software pointers from the third storage system to the data elements of the second storage system. The software pointers may be correspondingly associated with the data elements of the second storage system. The method also includes generating, with the third storage system, a virtual copy of at least a portion of the data of the second storage system.

The method may also include providing, with the third storage system, the at least a portion of the data of the second storage system to one or more network users. The method may also include providing a test environment to the one or more network users, wherein the one or more network users operate on the at least a portion of the data of the second storage system without interference to the first and second storage systems.

The method may further include providing access to the first storage system by a plurality of network computer users to store data with the first storage system. The second storage system may be an enterprise resource planning recovery database that is communicatively coupled to the first storage system to replicate the data therefrom.

In another embodiment, a data recovery system includes a first database having a plurality of data elements and a processor communicatively coupled to the first database via a plurality of pointers. Each pointer is associated with a data element of the first database and wherein the processor is configured for generating a second database that includes a least a portion of the plurality of data elements of the first database based on the association of the pointers to the data elements of the first database. In this regard, the processor may include software instructions that link the database elements of the first database to the processor via software pointers to generate the second database.

The data recovery system may also include an interface for providing the second database to at least one network user without interruption to the database operability of the first database. For example, the interface is a network interface configured for providing access to the second database to the at least one network user. The at least one network user (e.g., a system administrator or the like) may then operate on at least a portion of the data elements of the second database without changing the data elements of the first database.

The data recovery system may further include a third database configured for interfacing with a plurality of network users and storing data therefrom. The third database may be further configured for interfacing with the first database. The first database may be configured for maintaining a copy of the data stored with the third database.

### BRIEF DESCRIPTION OF THE DRAWINGS

FIG. 1 is a block diagram of a prior art ERP disaster recovery system.

FIG. 2 is a block diagram of an exemplary ERP disaster recovery system.

FIG. 3 is a block diagram of another exemplary ERP disaster recovery system.

FIG. 4 is a flow chart of an exemplary ERP disaster recovery process.

### DETAILED DESCRIPTION OF THE DRAWINGS

Reference will now be made to the accompanying drawings, which assist in illustrating the various pertinent features of the present invention. Although the present invention will now be described primarily in conjunction with an ERP disaster recovery system, it should be expressly understood that the present invention may be applicable to other applications of data recovery. In this regard, the following description of an exemplary ERP disaster recovery system is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain modes known of practicing the inventions and to enable others skilled in the art to utilize the invention in such, or other embodiments and with various modifications required by the particular application or use of the present invention.

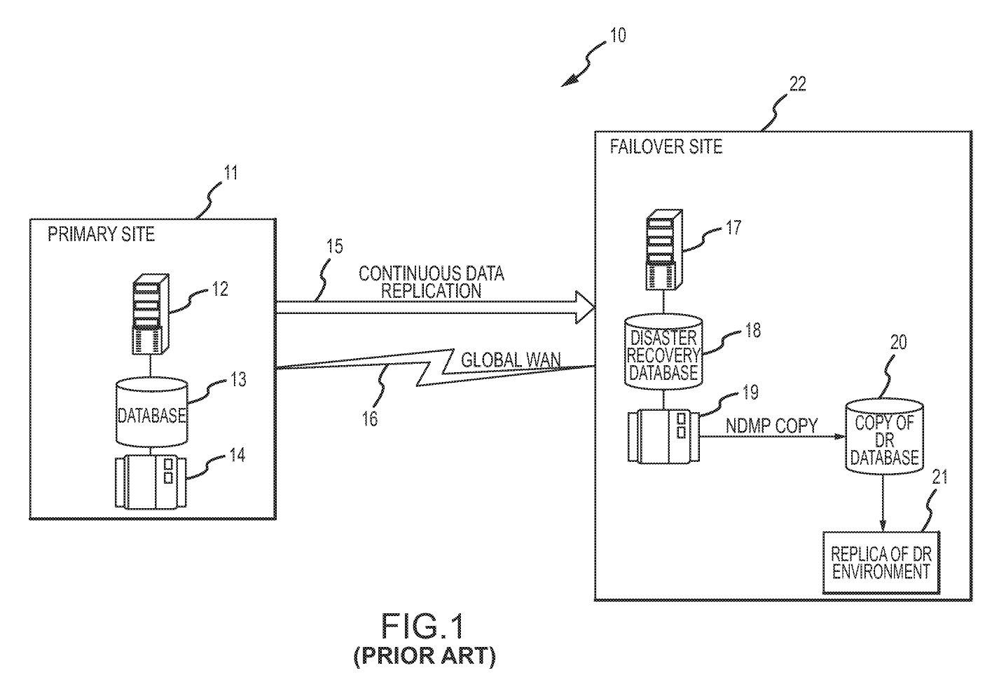

Turning now to the drawings, FIG. 1 is a block diagram of a prior art ERP disaster recovery system 10. The ERP disaster recovery system 10 includes a primary site 11 and a failover site 22, wherein the failover site provides data assurance and recovery capabilities for the primary site. For example, the primary site 11 may include a network server 12 that allows a plurality of networked computer users to access a database 13 stored with a storage system 14 (e.g., a disk array). To reduce the risk of ERP data loss, the primary site 11 is communicatively coupled to the failover site 22 via a communication link 16 (e.g., a global Wide Area Network, or “WAN”) to provide the data of the database 13 to the failover site 22 for continuous data replication 15 of the database 13. In this regard, the failover site 22 may include a network server 17 that receives the data of the database 13 and provides a duplicate of the database 13 in case of disaster (e.g., disaster recovery database 18). The disaster recovery database is stored with a storage system 19 (e.g., a disk array).

With the data of the database 13 replicated, certain users (e.g., system administrators and/or other information technology personnel) can access the data of the database 13 by accessing the database 18 without risk of data loss or interference to the database and storage operations of the primary site 11. For example, a system administrator may wish to test a new database software application on actual data of a database. To prevent loss of actual data (i.e., in a primary site, such as the primary site 11) the system administrator may test the software application on backup data (i.e., in a failover site, such as the failover site 22). However, to avoid the risk of data loss and interference to the database and storage operations of the failover site 22 (i.e., the “backup” of the primary site 11), the failover site 22 generates a copy 20 (also known as a “refresh”) of the disaster recovery database 18 such that the system administrator may operate on the disaster recovery data in a test environment 21.

Since the copy 20 of the disaster recovery database 18 is a duplicate of the data therein, the copy 20 can be exceptionally large (e.g., on the order of terabytes). For example, as the primary site 11 is configured to store data from a plurality of network users, possibly hundreds or even thousands, the data stored with the database 13 may be exceptionally large. Being a duplicate of the database 13, the disaster recovery database 18 is also exceptionally large. Thus, the failover site 22 must generate an exceptionally large amount of data when it provides a copy 20 of the disaster recovery database 18 when a system administrator requests access to actual data for testing purposes.

Additionally, since the primary site 11 may serve a plurality of organizations (e.g., business units within an enterprise or the like), each entity may have its own system administrator(s) with each of those having their own access requests to the copy 20 of the disaster recovery database 18. Since it is generally necessary for data testing to be performed on actual data, a copy 20 of the disaster recovery database 18 may be generated multiple times. For example, each system administrator may request access to actual data for testing. With each request, the copy 20 of the disaster recovery database 18 is generated to ensure that each request is the filled with “fresh” or actual data. Generating data on the order of terabytes generally takes inordinate amount of time; however, doing so multiple times (e.g., for each request) may become overwhelming for the failover site 22 and even cause some requests to go unfulfilled.

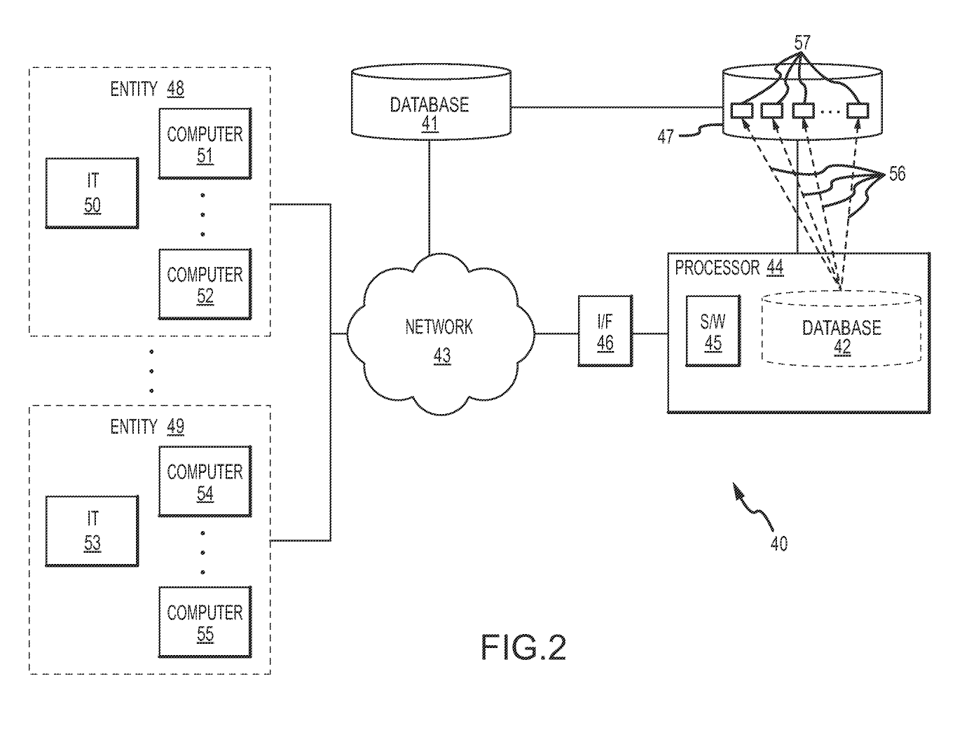

FIG. 2 is a block diagram of an exemplary ERP disaster recovery system 40 that may alleviate problems associated with the data refresh process of FIG. 1. In this embodiment, the ERP disaster recovery system 40 includes a database 41 that is coupled to a plurality of entities 48 and 49 (e.g., business units within an enterprise). To prevent the loss of data from these entities 48 and 49, the ERP disaster recovery system 40 is configured with a backup database 47 that replicates the data stored within the database 41 (e.g., a failover site). The ERP disaster recovery system 40 also includes a processor 44 that, among other things, may extract data from the database 47 as a sort of virtual database 42 for access to the actual data of the database 41 without substantial interruption to the database and storage operations of either the database 41 or the backup database 47.

Each entity 48 and 49 may include a plurality of network users that access the database 41 via their computers (e.g., computers 51, 52, 54, and 55) to store and/or change data within the database 41. Additionally, each entity 48 and 49 may include one or more network IT personnel that may require access to the data of the database 41 via their computers (e.g., IT modules 50 and 53). As mentioned, these IT personnel generally access the actual data of the database 41 via a backup database 42 so as to not interrupt database and storage operations of the database 41. However, in the prior art ERP system 10 of FIG. 1, an actual copy of the backup database was generated in response to an access request by the IT personnel. In this regard, the ERP disaster recovery system 40 includes the processor 44 which employs software instructions 45 to generate a plurality of pointers 56 that reference a plurality of data elements 57 in the backup database 47. For example, software instructions 45 may direct the processor 44 to generate a plurality of software pointers 56 that are correspondingly associated with the data elements 57 of the backup database 47. These pointers 56, in essence, provide a “view” into the database 47 without actually replicating the data therein through a processor intensive copy algorithm.

In this regard, the processor 44 may deliver actual data of the database 41 in total or in part to one or more IT modules of the entities 48 and 49. For example, since the processor 44 provides a view into the database 47 without physically copying the actual data therein (e.g., providing disk storage), the processor 44 can readily provide all or a portion of the data to a user desiring access to actual data via the pointers 56. Such a process may be analogous to a “snapshot” of the data which generally only consumes a few megabytes, as opposed to copying the entire database which could be on the order of terabytes. Because the processor 44 is able to provide snapshot data of a few megabytes via the pointers 56, the processor 44 can fulfill requests for access in relatively little time (e.g., based at least in part on processor speeds).

To illustrate, assume that IT module 50 requests access for testing all the data from the entity 48 contained within the database 41. Similarly, the IT module 53 may request access for all the data of the entity 49 contained within the database 41 at roughly the same time. Previously, it was generally necessary that each request, being unique because they require unique data, had to be fulfilled sequentially because all of the actual data contained within a primary site database had to be refreshed via a copy of a failover site database. In other words, the refresh data associated with each request consumed processing resources and took a considerable amount of time to fulfill. In the ERP disaster recovery system 40, the processor 44 may fulfill the request of the IT modules 50 and 53 almost simultaneously since the time required for providing snapshots of the few megabytes and transferring the snapshots to the IT modules is almost negligible.

To transfer the snapshots to the IT modules, the ERP disaster recovery system 40 may also include an interface 46 that is communicatively coupled to the processor 44. For example, the interface 46 may be a communications interface that is operable to communicate with the entities 48 and 49 through a communications network 43 (e.g., a global WAN, the Internet, or the like).

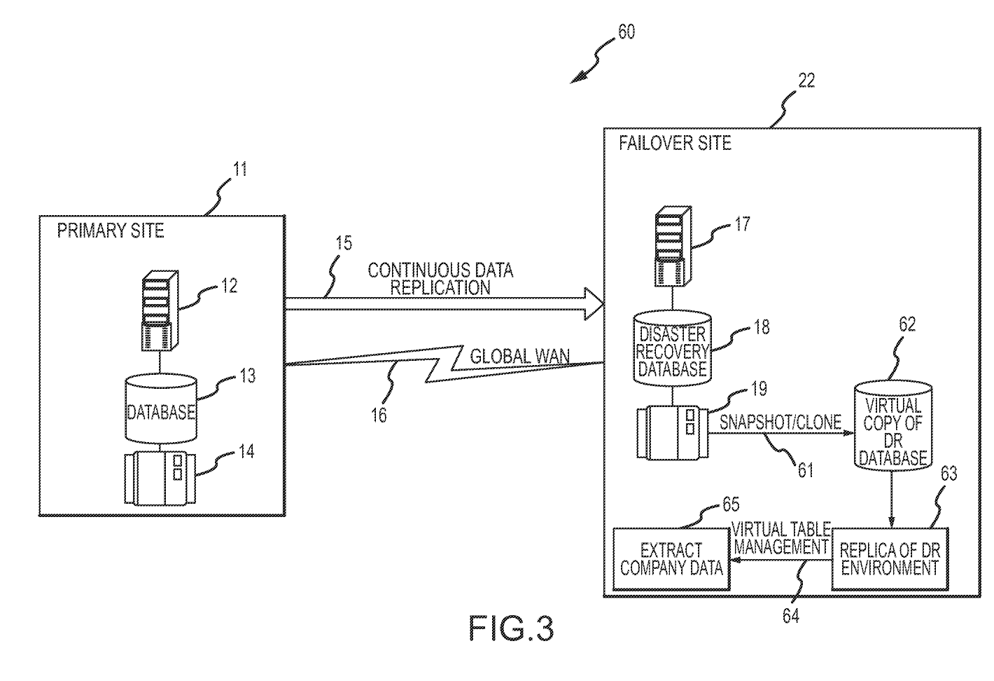

FIG. 3 is a block diagram of another exemplary ERP disaster recovery system 60. In this embodiment, the ERP disaster recovery system 60 is configured in a manner similar to that of the ERP disaster recovery system 10 of FIG. 1. For example, the ERP disaster recovery systems 60 includes a primary site 11 configured with a server 12 for providing access to a plurality of network users to the database 13 stored with the storage system 14. The primary site 11 is backed up via continuous data replication 15 over a global WAN 16 to a failover site 22. In this regard, the failover site 22 includes a server configured for communicating with the primary site to receive the continuous data replication 15 of the database 13 to configure the disaster recovery database 18. That is, the disaster recovery database 18, as a result of the backup, includes a copy of the database 13 and the data contained therein. The disaster recovery database 18 is similarly stored in the storage system 19.

Differing from the ERP disaster recovery system 10 of FIG. 1, is a snapshot/clone 61 that is taken of the database 18. For example, the processor 44 of FIG. 2 may be configured for generating a virtual copy 62 of the disaster recovery database 18 by configuring pointers to the data of the disaster recovery database 18. In this regard, a replica of the disaster recovery environment 63 can be managed via virtual table management 64 of the pointers to the disaster recovery database 18. Thus, data 65 may be continuously extracted without interruption to the storage and database operations of the disaster recovery database 18. In other words, the data 65 that is extracted is generally a continuous view into the disaster recovery database 18 via software pointers that are managed by the processor via the virtual table management 64, as described above in FIG. 2.

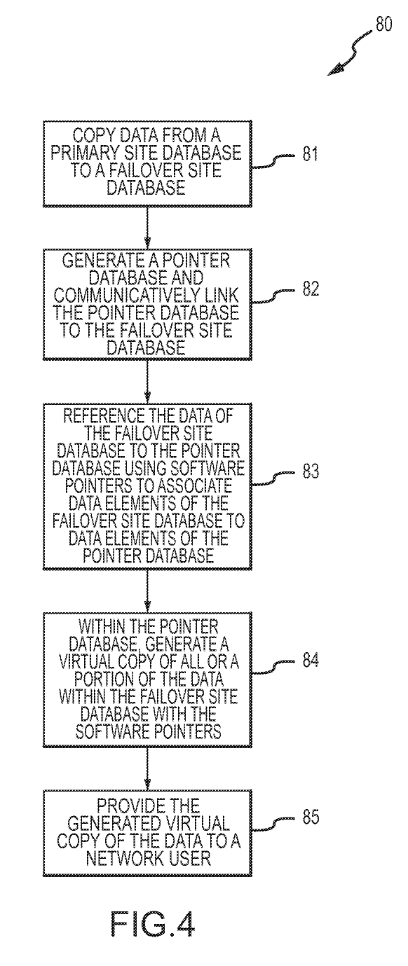

FIG. 4 is a flow chart of an exemplary ERP disaster recovery process 80. In this embodiment, the data is initially copied from a primary site database to a failover site database to ensure data recovery within an enterprise should the primary site database fail, in the process element 81. For example, a storage system may be configured within a primary site in which a plurality of network computer users store and/or change data within a database of the storage system. This data may be continually copied, or “backed up”, to a failover site storage system database in case the primary site ever fails.

To provide access to actual data without interrupting the storage and/or databasing operations of the primary site database and/or the failover site database, a pointer database may be generated and communicatively linked to the failover site database, in the process element 82. In this regard, the pointer database may reference the data of the failover site database by means of software pointers that associate data elements of the failover site database to the pointer database, in the process element 83. For example, the software pointers may provide a view into the failover site database such that the data elements therein may be provided as a snapshot of actual data in the primary site database. The software pointers may be managed via virtual table management that occupies relatively little storage space within a storage system. Thus, a virtual copy of all or a portion of the data within the failover site database, which also represents the data within the primary site database, may be generated by means of the software pointers, in the process element 84.

The generated virtual copy of the data (i.e., formed by the referencing of the software pointers to actual data) may then be provided to a network user for various applications, in the process element 85. For example, one or more network users may wish access to actual data to test various database applications. Previously, such access caused a substantial burden to databasing and storage operations of primary site and failover site databases. The referencing of the actual data contained within the failover site database, and thus the primary site database, substantially reduces the burden because, among other reasons, a snapshot of the data can be created from the software pointers which are managed by a physical space saving table.

Any other combination of all the techniques discussed herein is also possible. The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

What is claimed is:

1. A system for testing data, including:
a first database that stores data from a plurality of computers of a network;
a processor communicatively coupled to the first database and configured for generating a second database, wherein the second database is linked to the first database with a plurality of pointers and wherein the pointers are associated with data elements of the first database; and
an interface communicatively coupled to the processor to provide at least a portion of the second database for testing without interruption to the data of the first database.

2. The system of claim 1, further including a third database that is communicatively coupled to the plurality of computers of the network to store the data therefrom.

3. The system of claim 2, wherein the first database is an enterprise resource planning recovery database that is communicatively coupled to the third database to replicate the data therefrom.

4. The system of claim 1, wherein at least a portion of the plurality of computers is associated with a first entity and wherein the first entity includes at least one information technology computer configured for linking to the processor to access said least a portion of the second database.

5. The system of claim 4, wherein the at least one information technology computer is further configured for operating on data elements of said at least a portion of the second database.

6. The system of claim 4, further including an interface configured for communicatively coupling said at least one information technology computer to the processor.

7. The system of claim 1, wherein the processor includes software instructions to provide the plurality of pointers to the data elements within the first database in the form of software pointers.

8. A method of recovering data in a networked storage system, including:
copying data from a first storage system to a second storage system;
linking a third storage system to the second storage system;
referencing the data of the second storage system to the third storage in response to linking the third storage system; and
with the third storage system, generating a virtual copy of at least a portion of the data of the second storage system.

9. The method of claim 8, further including, with the third storage system, providing said at least a portion of the data of the second storage system to one or more network users.

10. The method of claim 9, further including providing a test environment to the one or more network users, wherein the one or more network users operate on said at least a portion of the data of the second storage system without interference to the first and second storage systems.

11. The method of claim 8, wherein referencing includes providing a plurality of pointers from the third storage system to data elements of the second storage system.

12. The method of claim 11, wherein providing a plurality of pointers includes processing software instructions to generate a plurality of software pointers from the third storage system to the data elements of the second storage system, wherein the software pointers are correspondingly associated with the data elements of the second storage system.

13. The method of claim 8, further including providing access to the first storage system by a plurality of network computer users to store data with the first storage system.

14. The method of claim 8, wherein the second storage system is an enterprise resource planning recovery database that is communicatively coupled to the first storage system to replicate the data therefrom.

15. A data recovery system, including:
a first database having a plurality of data elements;
a processor communicatively coupled to the first database via a plurality of pointers, wherein each pointer is associated with a data element of the first database and wherein the processor is configured for generating a second database that includes a least a portion of the plurality of data elements of the first database based on the association of the pointers to the data elements of the first database.

16. The data recovery system of claim 15, further including an interface for providing the second database to at least one network user without interruption to the database operability of the first database.

17. The data recovery system of claim 16, wherein the interface is a network interface configured for providing access to the second database to the at least one network user, wherein the at least one network user operates on at least a portion of the data elements of the second database without changing the data elements of the first database.

18. The data recovery system of claim 15, further including a third database configured for interfacing with a plurality of network users and storing data therefrom, wherein the third database is further configured for interfacing with the first database and wherein the first database is configured for maintaining a copy of the data stored with the third database.

19. The data recovery system of claim 15, wherein the processor includes software instructions that link the database elements of the first database to the processor via software pointers to generate the second database.
